(19) United States
(12) Patent Application Publication
(10) Pub. No.: US 2004/0190190 A1
(43) Pub. Date: Sep. 30, 2004

(54) Storage medium transporting apparatus with an improved transmission mechanism for driving a picker

(75) Inventor: Kiyoaki Egawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/809,364

(22) Filed: Mar. 26, 2004

(30) Foreign Application Priority Data
Mar. 31, 2003 (JP) 97213/2003

(51) Int. Cl. G11B 15/68

(52) U.S. Cl. 360/92

(57) ABSTRACT

An apparatus for transporting a storage medium from a holder to a storage device is disclosed. In order to reduce the weight of a carriage including a picker, the picker is driven by a driving device provided on a base outside the carriage. The driving force generated by the driving device is transmitted to the picker by means of a transmission mechanism that does not interfere with the movement of the carriage between the holder and the storage device.

### BACKGROUND OF THE INVENTION

1. Field of the Invention

The present invention relates to a storage medium transporting apparatus and, more particularly to a storage medium transporting apparatus with a transmission mechanism for driving a picker.

2. Description of the Related Art

The known cartridges conventionally used in the information processing systems may include storage medium packing cartridges (to be referred to simply as cartridges hereinafter) packing storage media which store data in a form legible to computers, such as magnetic tape cartridges, magnetic disk cartridges, compact disk cartridges, etc.

A cartridge transporting apparatus has a carriage which carries a cartridge picker for inserting or extracting a cartridge into or from a cartridge holder. The cartridge picker is allowed to move back and forth along a line so as to achieve the insertion or removal of a cartridge into or from a cartridge holder. The cartridge transporting apparatus has, in addition to the cartridge picker having a pair of hooks on its tips for holding a cartridge, a cartridge picker driving motor for moving the cartridge picker back and forth with respect to the carriage via a transmission mechanism.

The cartridge picker may be guided back and forth, by means of members such as rods, in directions along which the insertion or extraction of a cartridge into or from a cartridge holder occurs (see, for example, Japanese Unexamined Patent Application Publication No. 11-328816). The cartridge picker may release or hold a cartridge by opening or closing a pair of hooks using cam members (see, for example, Japanese Unexamined Patent Application Publication No. 10-40616). The guide members of the cartridge picker may be arranged on both sides of one end (entry) of the carriage base (see, for example, Japanese Unexamined Patent Application Publication No. 7-334910).

The cartridge picker and the carriage are moved vertically by means of a carriage driving motor. Thus, the cartridge picker and carriage can be freely moved between a cartridge drive on one hand and a desired cartridge holder provided in a cartridge library on the other. With the cartridge transporting apparatus, it is possible to transport a cartridge from the cartridge drive to a desired blank cartridge holder, or conversely a desired cartridge lodged in a cartridge holder to the cartridge drive.

However, according to the cartridge transporting apparatuses based on prior art techniques described above, since a cartridge picker driving motor is placed on a carriage base, it increases not only the overall weight of the carriage, but also its consumption of electric power.

According to the cartridge transporting apparatuses based on prior art techniques described above, a large number of elements are required for moving a cartridge picker in directions along which the insertion or extraction of a cartridge into or from a cartridge holder occurs, and for opening and closing a pair of hooks. Because of this, the conventional apparatuses require numerous elements for their operation which may hamper weight saving and miniaturization of the system and lead to the increased cost.

### BRIEF SUMMARY OF THE INVENTION

In view of the above problems of the systems based on conventional techniques, an object of the present invention is to provide a storage medium transporting apparatus which can reduce the weight of the elements driven by a carriage driving motor and overall power consumption.

Another object of the present invention is to provide a storage medium transporting apparatus which requires, for its operation, such a small number of elements that it can reduce its weight, contract its size and lower its production cost as compared with conventional equivalents.

The present invention provides an apparatus for transporting a storage medium from a holder to a storage device. In accordance with the present invention, the apparatus comprises a base, a carriage, a picker, a first driving device, a second driving device, and a transmission mechanism. The carriage is driven by first driving force and movable relative to the base between the holder and the storage device. The picker is provided on the carriage and driven by second driving force. The picker selectively loads and unloads the storage medium. The first driving device generates the first driving force. The second driving device is provided on the base and generates the second driving force. The transmission mechanism transmits the second driving force from the second driving device to the picker, allowing movement of the carriage. That is, the transmission mechanism does not interfere with the movement of the carriage relative to the base.

The transmission mechanism may comprise a rotary shaft and a coupling device. The coupling device is provided on the carriage and transmits torque from the rotary shaft to the picker allowing relative movement between the rotary shaft and the picker along a longitudinal axis of the rotary shaft.

The rotary shaft may have a convex portion in cross section, the coupling device may have a concave portion in cross section, and the convex portion of the rotary shaft fits the concave portion of the coupling device.

The rotary shaft may have a polygonal shape in cross section. The rotary shaft may have a rectangular shape in cross section.

The coupling device may comprise a spline bearing.

The rotary shaft and the coupling device may engage each other by means of a key and a keyway.

The transmission mechanism may comprise a belt and a gear. The belt allows relative movement between the driving device and the picker, and the gear is provided on the carriage and transmits driving force from the belt to the picker.

The belt may be elastic. The belt may comprise a spring.

The picker may comprise a gripper assembly grasping the storage medium.

The picker may comprise a support structure translating the gripper assembly in a direction toward and away from the holder.

The gripper assembly may comprise an arm and a guide guiding the arm. The arm selectively assumes an open position and a closed position. The guide has a curved portion such that the arm moves from the closed position to the open position as the arm approaches the holder and the arm moves from the open position to the closed position as the arm retreats from the holder.

The holder may be a library.

The storage medium may be housed in a cartridge.

The present invention provides a storage medium library system.

In accordance with the present invention, the storage medium library system may comprise a base, a carriage, picker, a first driving device, a second driving device, a transmission mechanism, and one or more storage holders which holds the storage media. The carriage is driven by first driving force and movable relative to the base between the holder and the storage device. The picker is provided on the carriage and driven by second driving force. The picker selectively loads and unloads the storage medium. The first driving device generates the first driving force. The second driving device is provided on the base and generates the second driving force. The transmission mechanism transmits the second driving force from the second driving device to the picker, allowing movement of the carriage.

The present invention provides an apparatus for transporting a storage medium from a holder to a storage device. In accordance with the present invention, the apparatus may comprise base means, carriage means, picker means, first driving means, second driving means, and transmission means. The carriage means is driven by first driving force and movable relative to the base means between the holder and the storage device. The picker means is provided on the carriage means and driven by second driving force. The picker means selectively loads and unloads the storage medium. The second driving means is provided on the base means and generates the second driving force. The transmission means transmits the second driving force from the second driving means to the picker means allowing movement of the carriage means.

### BRIEF DESCRIPTION OF THE DRAWINGS

The novel features believed characteristic of the invention are set forth in the appended claims. The invention itself, as well as other features and advantages thereof, will be best understood by reference to the detailed description which follows, read in conjunction with the accompanying drawings, wherein:

FIG. 1 is a schematic lateral view of a cartridge transportation system with a cartridge picker and carriage representing a first embodiment of the invention for outlining its constitution;

FIG. 2 is a perspective view of the cartridge transportation system seen from its bottom;

FIG. 3 is a perspective view of the cartridge transportation system seen from its top;

FIG. 4 is a perspective top view of part of the cartridge transportation system with an emphasis on the relationship among a base bracket, a motor and gears;

FIG. 5 is a perspective bottom view of part of the cartridge transportation system with an emphasis on the relationship among the base bracket, motor and gears;

FIG. 6 is a perspective view of the cartridge transportation system with an emphasis on the relationship between the base bracket and a frame;

FIG. 7 is a perspective view of the cartridge picker enclosed by the carriage;

FIG. 8 is a schematic top view of the cartridge picker combined with the carriage;

FIG. 9 is a top view for showing the cartridge picker combined with the carriage;

FIG. 10 is a bottom view for showing the cartridge picker combined with the carriage;

FIG. 11 is an enlarged view of part A in FIG. 10;

FIG. 12 is a bottom view of the carriage for showing the structure of a carriage cover;

FIG. 13 is a perspective view of hands and fingers with their constitutive elements being disintegrated for illustration;

FIG. 14 is a perspective view of a finger with its constitutive elements being disintegrated for illustration;

FIG. 15 is a diagram for illustrating the operation of the cartridge transportation system;

FIG. 16 is another diagram for illustrating the operation of the cartridge transportation system;

FIG. 17 is yet another diagram for illustrating the operation of the cartridge transportation system;

FIG. 18 is yet another diagram for illustrating the operation of the cartridge transportation system;

FIG. 19 is yet another diagram for illustrating the operation of the cartridge transportation system;

FIG. 20 is yet another diagram for illustrating the operation of the cartridge transportation system;

FIG. 21 is yet another diagram for illustrating the operation of the cartridge transportation system;

FIG. 22 is yet another diagram for illustrating the operation of the cartridge transportation system;

FIG. 23 is yet another diagram for illustrating the operation of the cartridge transportation system;

FIG. 24 is yet another diagram for illustrating the operation of the cartridge transportation system;

FIG. 25 is yet another diagram for illustrating the operation of the cartridge transportation system;

FIG. 26 is yet another diagram for illustrating the operation of the cartridge transportation system;

FIG. 27 is a diagram for illustrating the structure of a finger of a storage medium transporting apparatus with a cartridge picker and carriage representing a second embodiment of the invention;

FIG. 28 is a diagram for illustrating the operation of the above cartridge transportation apparatus; and

FIG. 29 is diagram for schematically showing the composition of an exemplary cartridge transportation system.

FIG. 30 is diagram for schematically showing the composition of an exemplary cartridge transportation system.

### DETAILED DESCRIPTION OF THE INVENTION

The preferred embodiments of the invention will be described below with reference to the attached drawings. The invention will be detailed by means of illustrative examples.

### FIRST EMBODIMENT

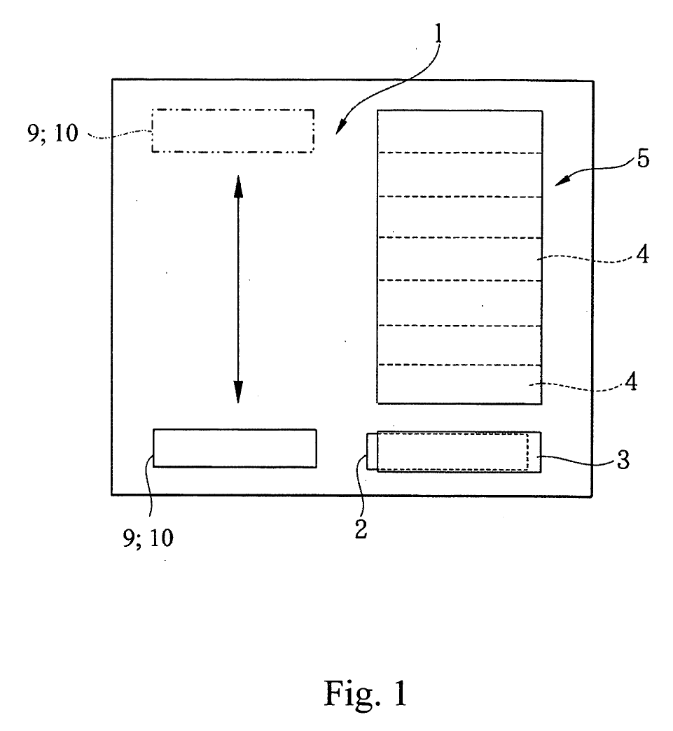

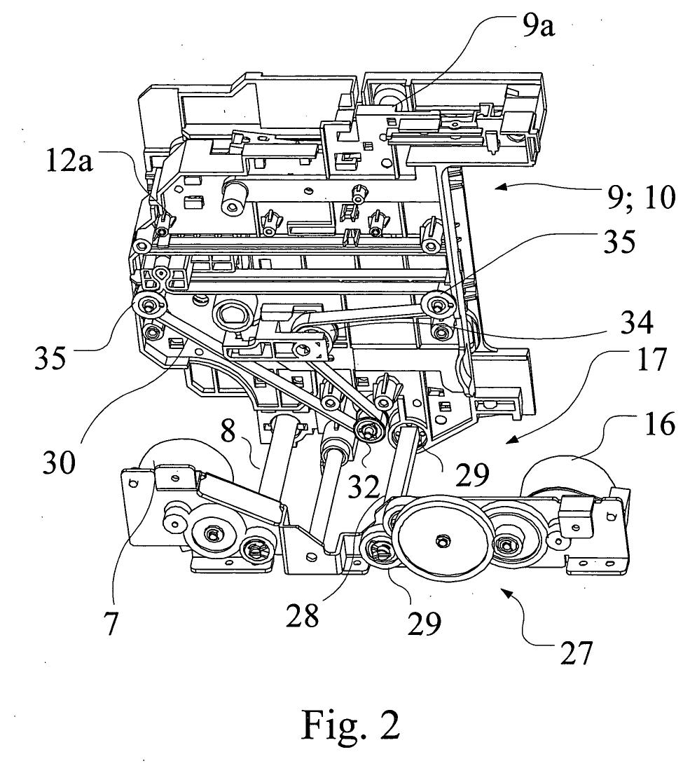

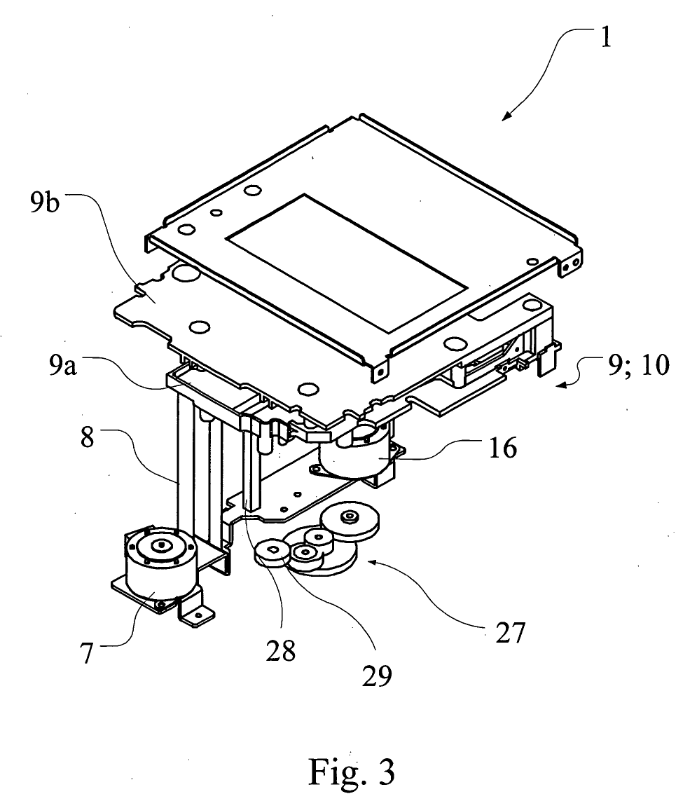

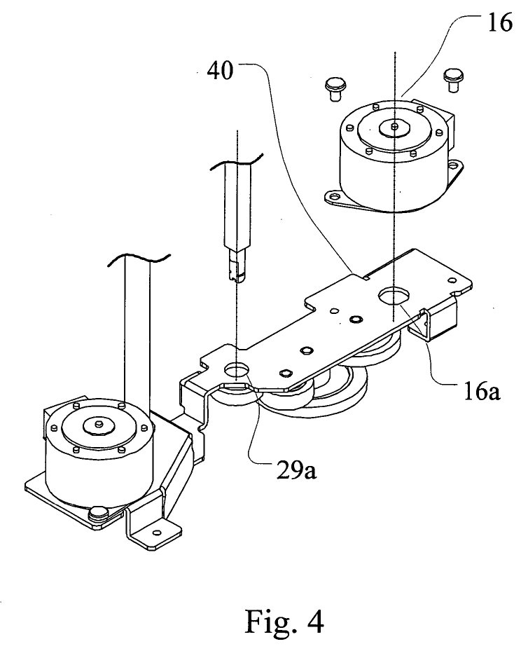

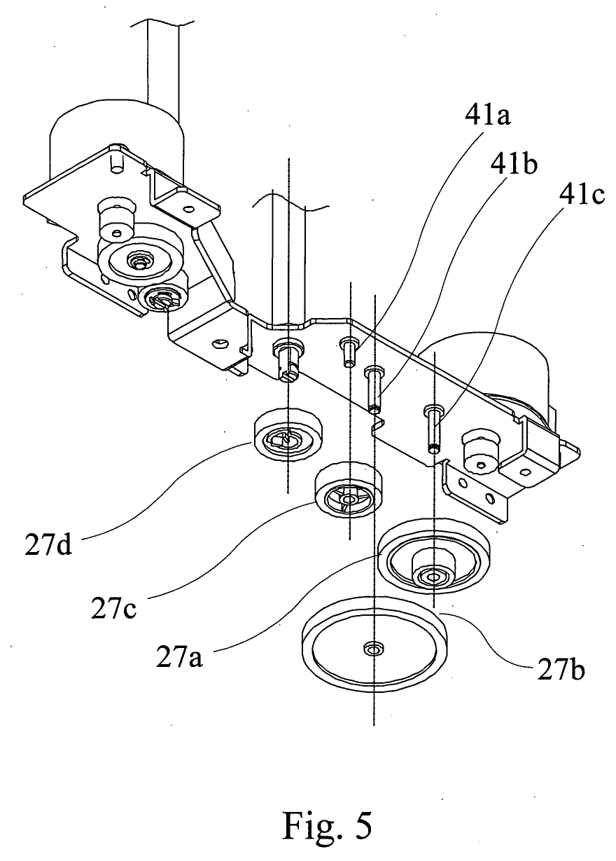

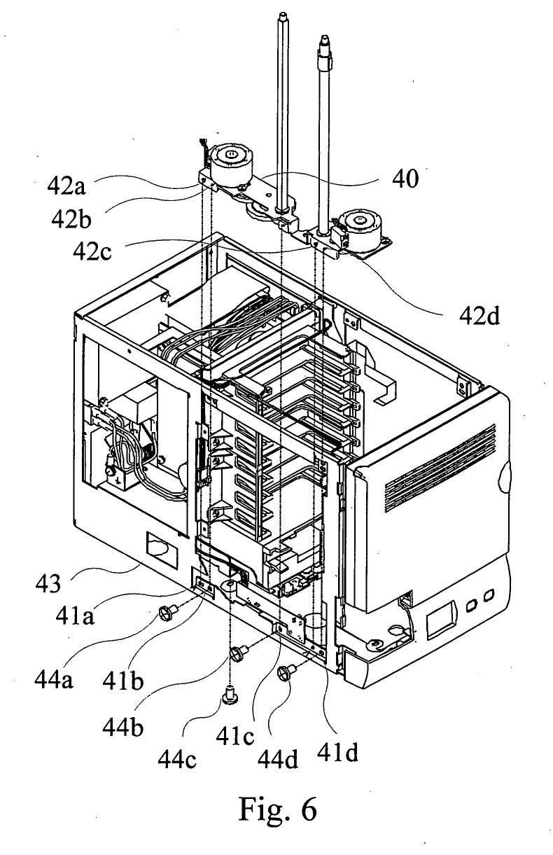

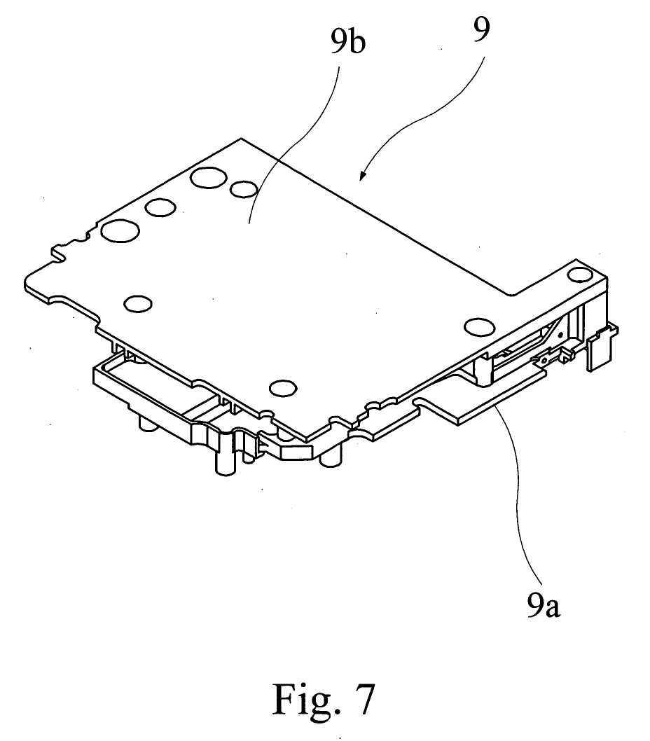

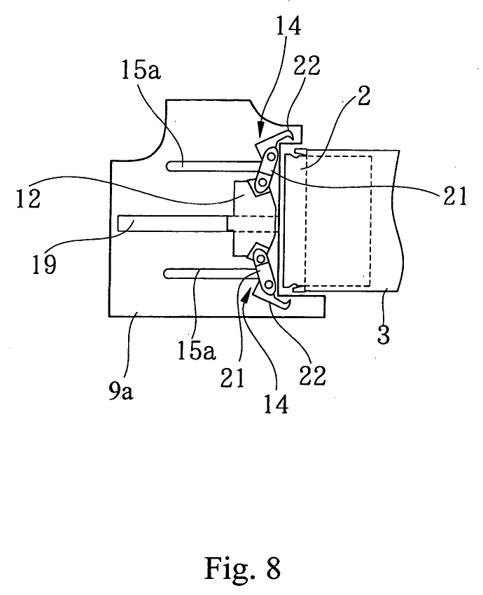

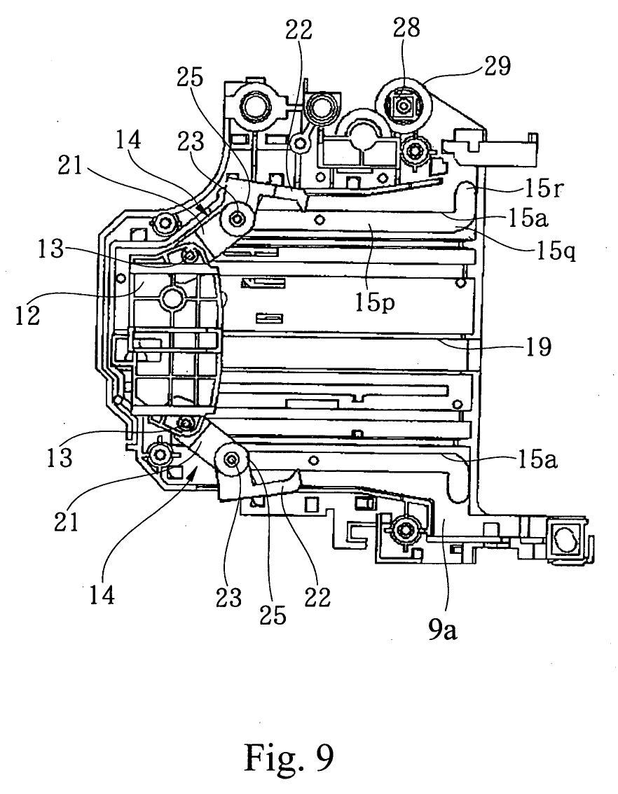

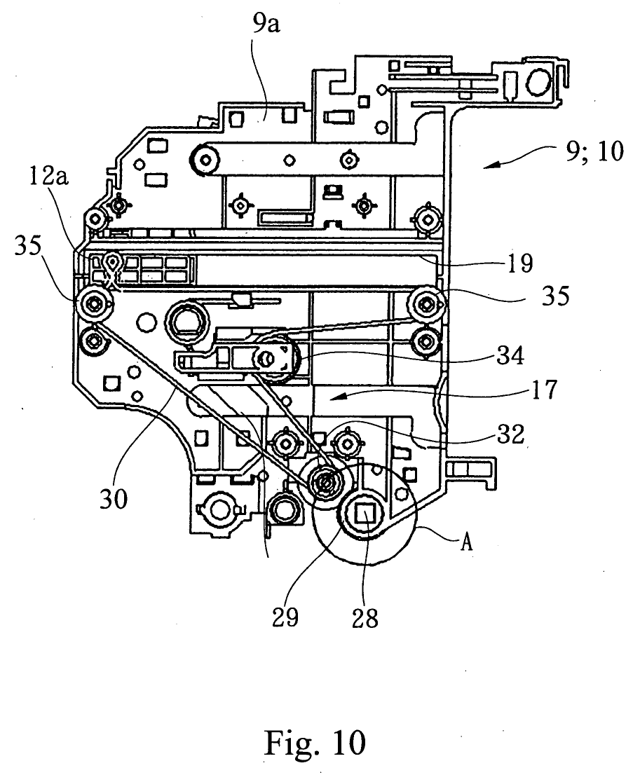

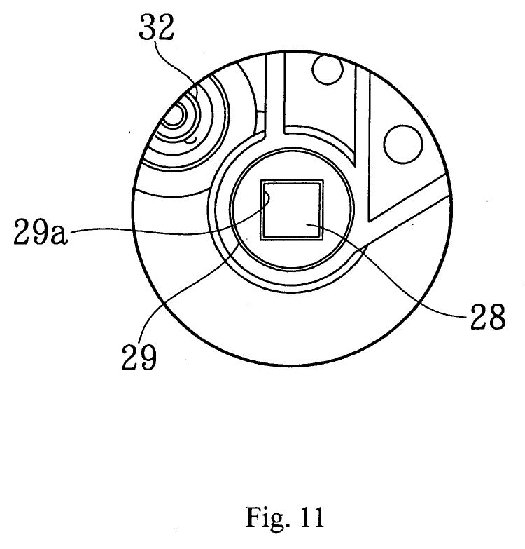

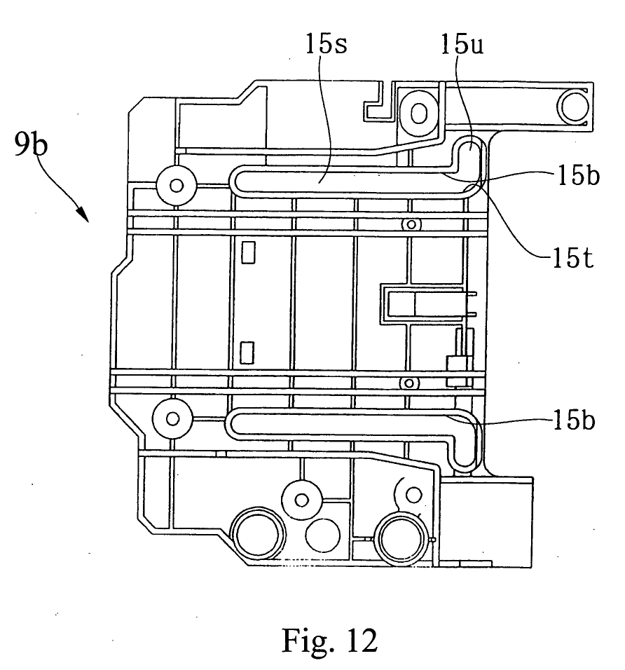

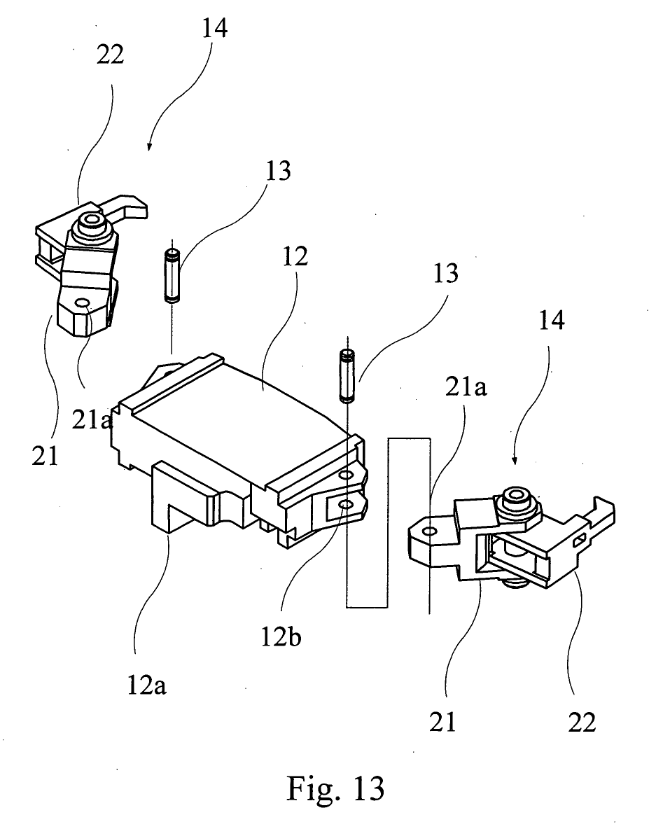

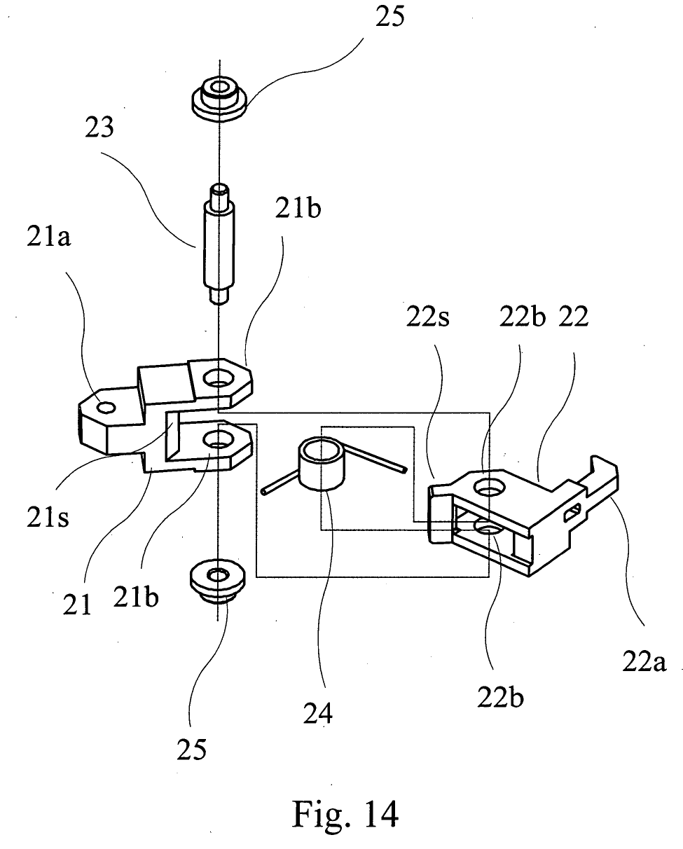

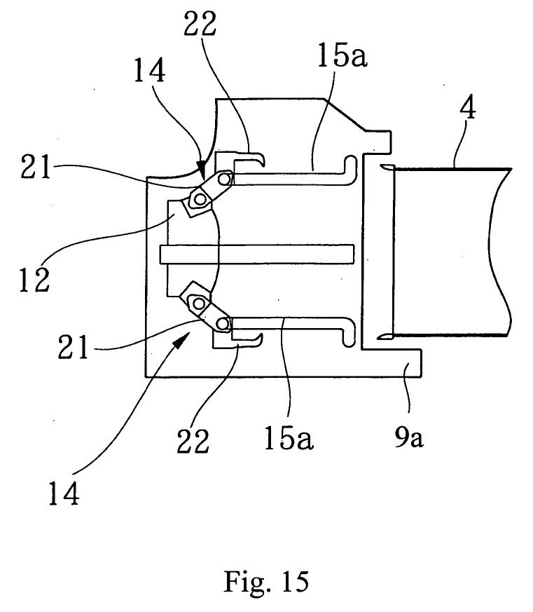

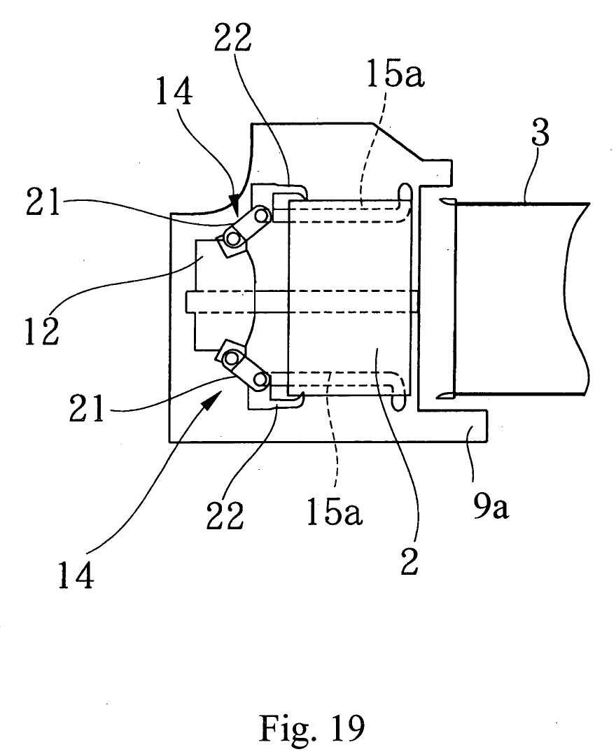

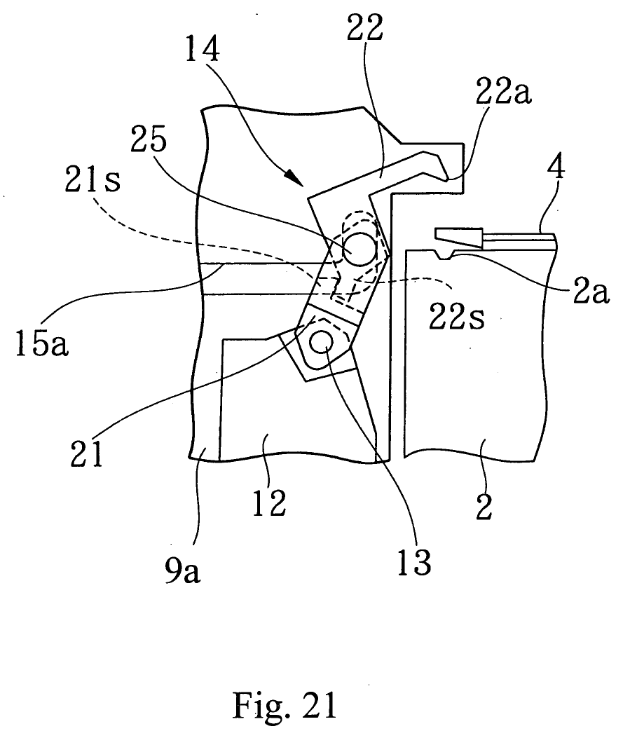

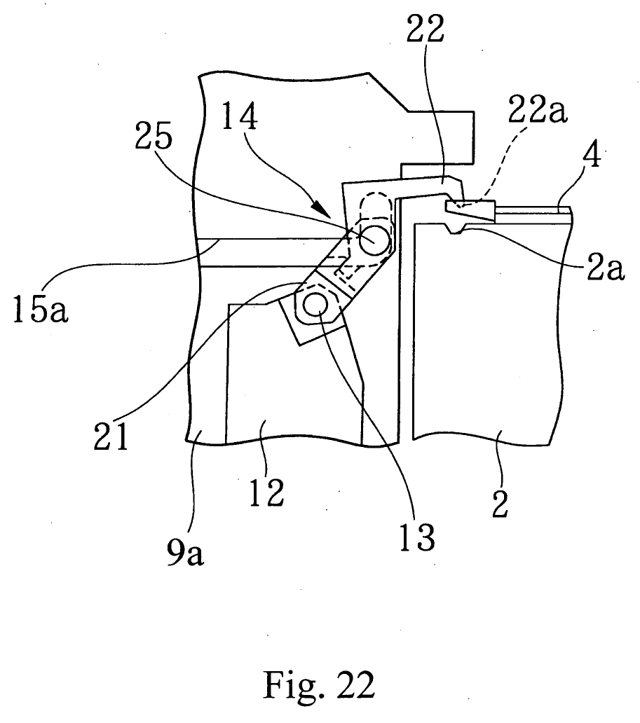

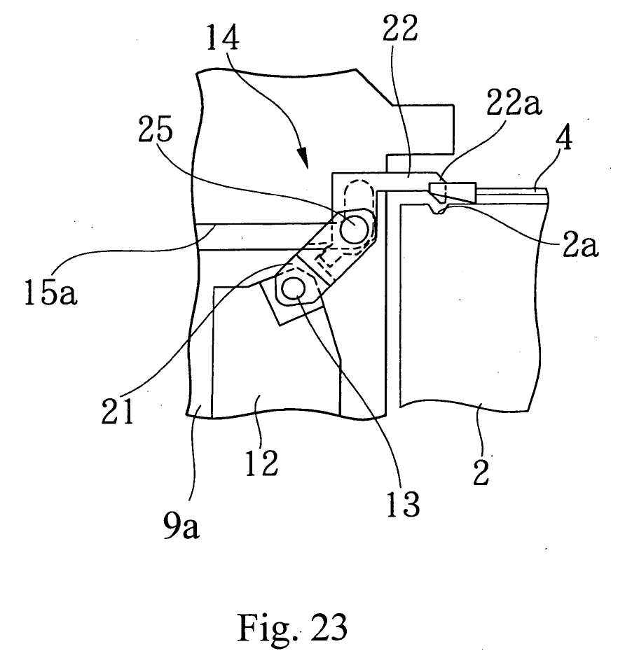

FIG. 1 is a schematic lateral view of a cartridge transportation system with a cartridge picker and carriage representing a first embodiment of the invention for outlining its constitution. FIG. 2 is a perspective view of the cartridge transportation system seen from its bottom. FIG. 3 is a perspective view of the cartridge transportation system seen from its top. FIG. 4 is a perspective top view of part of the cartridge transportation system with an emphasis on the relationship among a base bracket, a motor and gears. FIG. 5 is a perspective bottom view of part of the cartridge transportation system with an emphasis on the relationship among the base bracket, motor and gears. FIG. 6 is a perspective view of the cartridge transportation system with an emphasis on the relationship between the base bracket and a frame. FIG. 7 is a perspective view of the cartridge picker enclosed by the carriage. FIG. 8 is a schematic top view of the cartridge picker combined with the carriage. FIG. 9 is a top view for showing the cartridge picker combined with the carriage. FIG. 10 is a bottom view for showing the cartridge picker combined with the carriage. FIG. 11 is an enlarged view of part A in FIG. 10. FIG. 12 is a bottom view of the carriage for showing the structure of a carriage cover. FIG. 13 is a perspective view of hands and fingers with their constitutive elements being disintegrated for illustration. FIG. 14 is a perspective view of a finger with its constitutive elements being disintegrated for illustration. FIGS. 15 to 26 are diagrams for illustrating the operation of the cartridge transportation system.

Referring to FIG. 1, the inventive cartridge transportation system 1 constitutes a memory unit when connected, for example, to an information processing system. The cartridge 2 packs a storage medium such as a magnetic tape carrying information in a form legible to a computer. The cartridge transportation system 1 is responsible for transporting a cartridge 2 between a storage device, for example, a cartridge drive 3 and a cartridge library 5. The cartridge drive 3 is provided for rotating a storage medium in a cartridge 2 for reading or writing, and the cartridge library 5 has plural cartridge holders 4 for lodging cartridges 2.

Referring to FIGS. 2 and 3 the cartridge transportation system 1 further has a carriage driving motor 7 which serves as a carriage driving device for vertically moving a cartridge picker 10 and carriage 9. The cartridge transportation system 1 further has a lead shaft 8 which rotates being driven by the carriage driving motor 7 and helps the cartridge picker 10 and carriage 9 to be moved in parallel in vertical directions. According to the cartridge transportation system 1, it is possible for the cartridge picker 10 and carriage 9 to be moved back and forth between the cartridge drive 3 and a cartridge holder 4 lodging a desired cartridge 2 Thus, the cartridge picker 10 selectively loads a desired cartridge 2, or unloads a cartridge 2 to be returned to the library.

The lead shaft 8 has a male threaded portion screwed in on its tip. The male threaded portion mates with a female threaded portion formed on a specified position of a carriage base 9a described below. As the lead shaft 8 rotates, the cartridge picker 10 and carriage 9 move in parallel along the lead shaft 8 in vertical directions.

Referring to FIG. 7, the carriage 9 comprises a carriage base 9a and carriage cover 9b for covering the cartridge picker 10. Referring to FIG. 8, the cartridge picker 10 comprises a gripper assembly grasping the cartridge and a support structure translating the gripper assembly in a direction toward and away from the holder. The gripper assembly comprises arms and guides guiding the arms. The arms selectively assume an open position and a closed position. The guides have a curved portion such that the arms move from the closed position to the open position as the arms approach the holder and the arms move from the open position to the closed position as the arms retreat from the holder.

Referring to FIGS. 13 and 14, for example, the gripper assembly comprises a hand 12, hand shafts 13, fingers 14, finger arms 21, nails 22, finger shafts 23, twisted coil springs 24, and bushes 25 as the arms. Referring to FIG. 8, the gripper assembly further comprises L-shaped cams 15, and a guide groove 19 as the guides. The support structure comprises a linear guide groove 19.

Referring to FIG. 2, the cartridge picker 10 is enclosed by the carriage 9. Referring to FIG. 8, the cartridge picker 10 has, over the carriage base 9a, a hand 12 which can move back and forth in directions along which the insertion or extraction of a cartridge 2 into or from a cartridge holder 4 occurs (hereinafter referred to as “unloading direction” and “loading direction”, respectively). Referring to FIG. 13, the pair of fingers 14 are linked rotatably to the hand 12 via hand shafts 13. Referring to FIG. 8, the pair of L-shaped cams 15a are formed as concavities on the carriage base 9a, and cause, as the hand 12 moves forth or back, the pair of fingers 14 to be rotated round the hand 12 to get close to each other (close) or apart from each other (open). The cartridge picker driving motor 16 is an exemplary picker driving device. Referring to FIGS. 2 and 8, the cartridge picker driving device is provided on a base bracket 40 described below, and generates driving force for the cartridge picker 10. More specifically, the cartridge picker driving motor 16 comprises a stepping motor for moving the hand 12 back and forth along the loading and unloading directions. The transmission mechanism 17 transmits driving force from the cartridge picker driving motor 16 to the hand 12.

As shown in FIG. 12, on the inferior side of the carriage cover 9b there are also formed a pair of L-shaped cams 15b identical in shape to the pair of L-shaped cams 15a, which also serve for rotating fingers 14 around the hand 12 as the hand 12 moves back and forth.

Referring to FIGS. 9 and 12, the carriage base 9a and cover 9b are obtained, for example, by molding a resin. The pairs of L-shaped cams 15a and 15b may be integrally molded.

Referring to FIGS. 9 and 13, the hand 12 has, on its bottom, a projection 12a which engages with a linear guide groove 19 formed on the carriage base 9a, and supports the linear movement of the hand 12 in the loading and unloading directions.

Referring to FIG. 13, the hand 12 and the fingers 14 are rotatably linked to each other by inserting hand shafts 13 through joining holes 12b and 21a. The joining holes 12b are formed on both distal edges of the hand 12, while the joining holes 21a on the ends of finger arms 21 belonging to the fingers 14. The finger arms 21 will be described later.

Referring to FIG. 14, each finger 14 comprises a finger arm 21, nail 22, finger shaft 23, twisted coil spring 24, and bushes 25. The finger arm 21 has a Y-shaped profile. The nail 22 has, on its distal end, a hook 22a which will engage with a V-shaped notch 2a formed on a lateral side of a cartridge 2. The finger shaft 23 is a rod-like shaft member which is inserted through a pair of joining holes 21b formed on the distal edge of a finger arm 21 and a pair of joining holes 22b formed on the central end of a nail 22 to join the finger arm 21 and the nail 22 together. The twisted coil spring 24 has its central hollowness penetrated by a finger shaft 23, and is arranged in a gap formed between the two pairs of joining holes 21b and 22b such that it forces a nail 22 to move inward, that is, to engage its hook 22a with a notch 2a on a lateral edge of a cartridge 2. Bushes 25 are made of a resin, and slide along the L-shaped cams 15a, 15b.

The finger shaft 23 is a rod-like shaft member. The finger arm 21 and the nail 22 are linked to each other rotatably round a finger shaft 23 which is inserted through the joining holes 21b and 22b formed through the finger arm 21 and the nail 22, respectively.

In this particular embodiment, the twisted coil springs 24 do not force the nails 22 to move inward, unless the nails 22 seize a cartridge 2. While the nails 22 seize a cartridge 2, the twisted coil springs 24 force the nails 22 to move inward to ensure the seizure.

As the hand 12 moves back and forth, the bushes 25, 25 slide through L-shaped cams 15a, 15b. As the hand 12 moves in the loading and unloading directions, the angle between the moving direction of the hand 12 and the longitudinal axis of the finger arm 21 varies, and with the, variation of the angle, the pair of fingers 14 get close to each other (close) or apart from each other (open).

Now, description will be given of the cartridge transportation system 1 when its cartridge picker 10 does not hold a cartridge 2 (inactive state). A ridge 21s formed on the distal edge of each finger arm 21 comes into close contact with a ridge 22s formed on the central edge of each nail 22 to form a joint. The nails 22 are restricted by the twisted coil springs 24 in their clockwise or counterclockwise rotation. As a consequence, the position of each nail 22 relative to a finger arm 21 jointed thereto is kept nearly constant (e.g., in terms of the angle between the longitudinal axis of the nail 22 and the longitudinal axis of the finger arm 21).

Description will be then given of the cartridge transportation system 1 when its cartridge picker 10 holds a cartridge 2 (active state). The pair of fingers 14 are expanded in opposition to the inward directing force exerted by the twisted coil springs 24, and the nails 22 rotate round the finger shafts 23 apart from the finger arms 21. The position of each nail 22 relative to a finger arm 21 jointed thereto varies in association (e.g., the angle between the longitudinal axis of the nail 22 and the longitudinal axis of the finger arm 21 becomes smaller by a certain specified amount). At this state, since the nails 22 are forced to move inward by the twisted coil springs 24 which tend to return to the original condition, they hold a cartridge 2 by seizing its lateral edges.

This embodiment is designed such that, when the hand 12 is retreated toward the rear portion of the carriage base 9a, the distance between the pair of hooks 22a on respective nails 22 becomes smaller than the width of a cartridge 2 which is seized by the hooks 22a. Thus, after the pair of fingers 14 are expanded in opposition to the inward directing force of the twisted coil springs 24, the twisted coil springs 24 tend to return to the original condition which generates a force required to holding a cartridge 2.

The cartridge transportation system 1 of the invention is designed such that the seizing force generated by the twisted coil springs 24 is sufficiently strong to firmly hold a cartridge 2, but not so strong as to damage the cartridge 2.

Referring to FIGS. 9 and 12, The L-shaped cams 15a, 15b comprises linear sections 15p, 15s consisting of a comparatively long linear limb running in the loading and unloading directions, curved sections 15q, 15t at their distal ends, and linear sections 15r, 15u consisting of a comparatively short linear limb running laterally in a direction nearly vertical to the loading and unloading direction.

The transmission mechanism 17 comprises a rotary shaft and a coupling device. The coupling device is provided on the carriage 9 and transmits torque exerted via the rotary shaft to the cartridge picker 10, thereby allowing the displacement of the cartridge picker 10 relative to the shaft along a longitudinal axis of the rotary shaft.

More specifically, as shown in FIG. 2, the transmission mechanism 17 comprises, for example, a gear train 27, a rectangular shaft 28, a cartridge picker gear 29, a belt 30, a pulley gear 32, idler pulleys 34, and belt pulleys 35. The gear train 27 serves as a mediator of the rotary movement of a cartridge picker driving motor 16. The rectangular shaft 28 is an exemplary rotary shaft for transmitting torque to the coupling device. The cartridge picker gear 29 includes a pair of gears provided on the carriage base 9a and the base bracket 40. The cartridge picker gear 29 on the carriage base 9a is an exemplary coupling device for transmitting torque to the rotary shaft. The belt 30 is attached to the hand 12 at its specified site. The pulley gear 32 has the belt 30 wound around its rim, and is spun via the rotation of the cartridge picker gear 29, thereby moving the belt 30. The belt pulleys 35 have the belt 30 wound around their rim, and are provided on both ends of the guide groove 19. The idler pulleys 34 give a tension to the belt 30.

Referring to FIGS. 4 and 5, the cartridge picker driving motor 16 and the gear train 27 are fixed to a base, for example, a base bracket 40. The base bracket 40 has a positioning hole 16a for positioning the cartridge picker driving motor and a through hole 29a formed thereon. Referring to FIG. 5, the base bracket 40 further has fixing shafts 41a, 41b and 41c for fixing intermediate gears fixed thereto. The gear train 27 comprises intermediate gears 27a, 27b, 27c and 27d. The base bracket 40 and the gear train 27 are so precisely designed and prepared with respect to each other that the shafts fixed to the base bracket 40 can accurately fit to the respective intermediate gears formed in the gear train 27. The driving force generated by the cartridge picker driving motor 16 is transmitted via the intermediate gears 27a to 27d to the rectangular shaft 28.

Referring to FIG. 6, the base bracket 40 has positioning embosses 42a, 42b, 42c, 42d and 42e (emboss 42e is not shown) formed thereon. When the positioning embosses 42a to 42e formed on the base bracket 40 are properly fitted to positioning pits 41a, 41b, 41c, 41d and 41e (pit 41e is not shown) formed on a frame 43, the base bracket 40 is rightly positioned with respect to the system body. The base bracket 40 is fastened to the frame 43 via screws 44a, 44b, 44c and 44d.

Referring to FIGS. 10 and 11, the rectangular shaft 28 has one end inserted into the through hole 29a having a nearly rectangular cross-section formed on the cartridge picker gear 29, and is designed such that it displaces vertically with respect to the cartridge picker gear 29. The rectangular shaft 28 transmits rotary force of the cartridge picker driving motor 16 transmitted via the cartridge picker gear 29 to the pulley gear 32. Since the belt 30 is wound around the pulley gear 32, rotation of the pulley gear 32 results in the movement of the belt 30.

Referring to FIG. 10, since the projection 12a of the hand 12 is fixed to the belt 30 at a specified site, the hand 12 moves along the guide groove 19 in association with the movement of the belt 30.

The belt 30 extends linearly along the guide groove 19 between the belt pulleys 35 being stretched taut by the belt pulleys 35.

Referring to FIG. 2, the cartridge picker driving motor 16, gear train 27 and cartridge picker gear 29 are fixed to the base bracket 40 apart from the carriage base 9a, and thus they do not move in association with the carriage base 9a. Their movement is independent of the movement induced by the carriage moving motor 7.

The carriage driving motor 7 is constructed with respect to the carriage 9 such that its rotation causes the linear vertical displacement of the carriage base 9a carrying the hand 12 and other elements. Rotation of a pulley gear 32 attached to the carriage base 9a results in the movement of the belt 30, and thus the hand 12 moves, on a horizontal plane over the carriage base 9a, linearly in the loading and unloading directions.

Next, the operation of the cartridge transportation system 1 embodying the invention will be described.

First, referring to FIG. 1, a control unit (not shown) locates a blank cartridge holder 4 which does not lodge any cartridge 2 out of plural cartridge holders 4. The control unit instructs the carriage driving motor 7 to move the picker 10 and carriage 9 to a level flush with the blank cartridge holder 4.

Namely, referring to FIG. 2, the control unit causes the carriage driving motor 7 to rotate the lead shaft 8 so that the carriage base 9a carrying the hand 12 and other elements can be moved vertically to the desired level. During the movement, the carriage base 9a is guided by means of the rectangular shaft 28 which is inserted into the through-hole 29a formed on the cartridge picker gear 29, as shown in FIG. 11.

Referring to FIG. 15, when the cartridge picker. 10 and carriage 9 are located opposite to the blank cartridge holder 4, the control unit instructs the cartridge picker driving motor 16 to move the cartridge picker 10 forward, that is, advance the hand 12 from its resting position towards the blank cartridge holder 4.

Namely, referring to FIG. 2, the rotary force of the cartridge picker driving motor 16 is transmitted via the gear train 27 and cartridge picker gear 29 to the rectangular shaft 28. The cartridge picker gear 29 rotates the rectangular shaft 28 while it is being displaced along a longitudinal axis of the rectangular shaft 28. The rotary force generated by the cartridge picker driving motor 16 and transmitted via the cartridge picker gear 29 is transmitted to the pulley gear 32. Rotation of the pulley gear 32 around which the belt 30 is wound results in the movement of the belt 30.

As a consequence, referring to FIG. 15, the hand 12, which is fixed to a specified site of the belt 30, moves linearly on a horizontal plane over the carriage base 9a along the guide groove 19 in the unloading direction.

In this embodiment, referring to FIG. 2, the cartridge picker driving motor 16, gear train 27 and cartridge picker gear 29 are fixed apart from the carriage base 9a, and remain in the same position in spite of the movement of the carriage base 9a. Thus, even when rotation of the carriage driving motor 7 causes the vertical displacement of the carriage base 9a carrying the hand 12 and other elements, the cartridge picker driving motor 16, gear train 27 and cartridge picker gear 29 remain in the same position in spite of the movement of the carriage base 9 caused by the carriage driving motor 7.

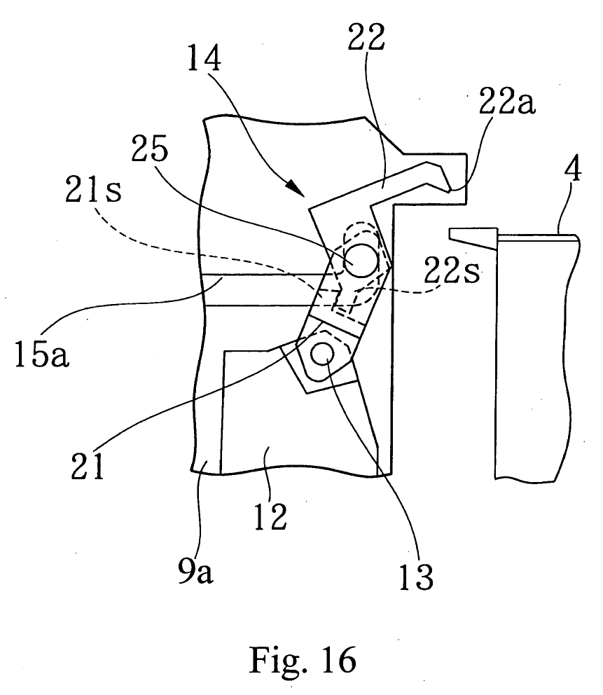

Referring to FIG. 16, the cartridge picker driving motor 16 causes the hand 12 to advance until, the lower and upper bushes 25, 25 of each finger arm 21 butt against the corners at the curved sections 15q, 15t of L-shaped cams 15a, 15b, to be forced to slide along the linear sections 15r, 15u. At this moment, both fingers 14 are expanded to be ready for seizing a cartridge 2.

Next, the manner how a cartridge 2 lodged in a specified cartridge holder 4 is extracted and transported to the cartridge drive 3 will be described.

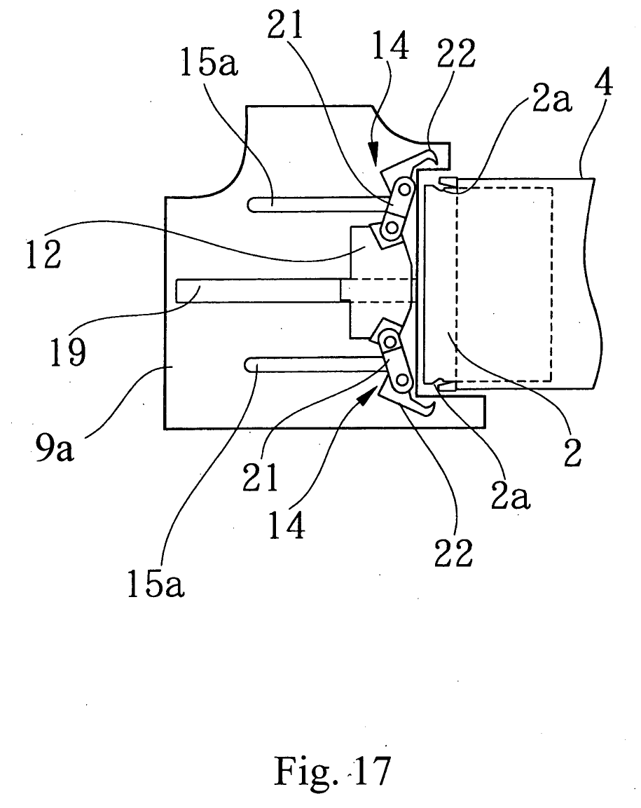

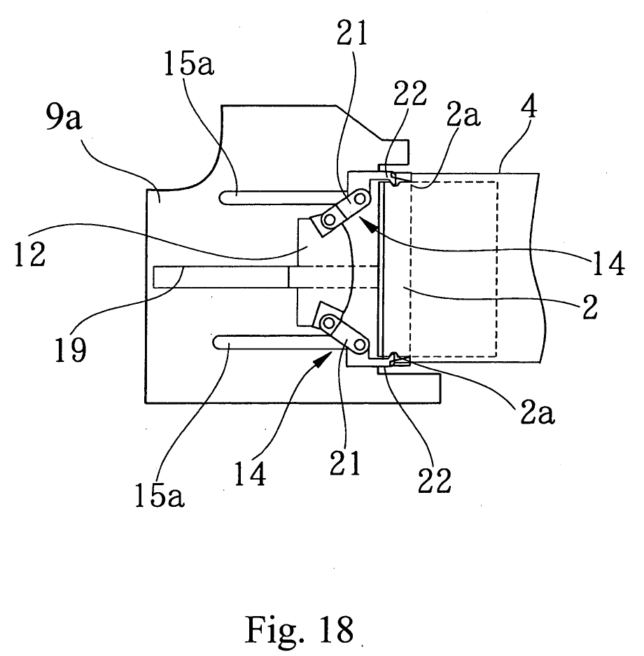

Referring to FIG. 17, the control unit instructs the carriage driving motor 7 to move the picker 10 and carriage 9 to a position opposite to a cartridge holder 4 lodging a desired cartridge 2 out of the plural cartridge holders 4. Referring to FIG. 18 and FIGS. 21 and 22, when the cartridge picker 10 is positioned in front of the cartridge holder 4, the hooks 22a of the nails 22 are placed close to the notches 2a of the cartridge 2.

Then, Referring to FIGS. 22, 23, 9, and 12, the control unit instructs the cartridge picker driving motor 16 to retreat the hand 12. Then, the lower bushes 25 (also upper bushes 25) of finger arms 21 move from the linear sections 15r, 15u of the L-shaped cams 15a, 15b towards their curved sections 15q, 15t. As the fingers 14 move close to each other with this movement, the hooks 22a of the nails 22 come closer to the notches 2a, 2a of the cartridge 2.

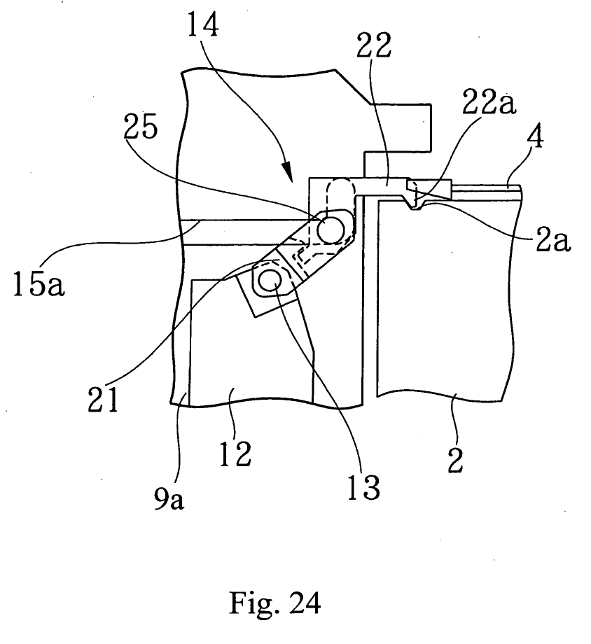

Referring to FIGS. 18, 24, the control unit causes the hand 12 to further retreat. Then, the fingers 14 further get close to each other until the hooks 22a of the nails 22 firmly engage with the notches 2a of the cartridge 2. Thus, the cartridge seizing operation is completed.

At this stage of seizing operation, however, the pair of fingers 14 are still expanded in opposition to the inward directing force imposed by the twisted coil springs 24. Namely, the nails 22 are rotated round the finger shafts 23 more apart from the finger arms 21 than in the inactive state: the position of the nail 22 relative to the finger arm 21 is still divergent from the corresponding relative position of the two elements observed in the inactive state (e.g., the angle between the longitudinal axis of the nail 22 and the longitudinal axis of the finger arm 21 is smaller by a specified amount than the corresponding angle in the inactive state).

During this state, since the nails 22 are forced to move inward by the twisted coil springs 24 which tend to return to the original condition, they can firmly hold the cartridge 2 by seizing its lateral edges.

Next, referring to FIGS. 19, 9, and 12, the control unit instructs the cartridge picker driving motor 16 to further retreat the hand 12. Then, the lower and upper bushes 25, 25 of finger arms 21 move beyond the corners of curved sections 15q, 15t of the L-shaped cams 15a, 15b along their long linear sections 15p, 15s to the rear end of the carriage base 9a. As a result, the cartridge 2 is transferred in the carriage 9 while the fingers 14 are firmly pressed on the lateral edges of the cartridge 2 due to the inward directing force,imposed by the twisted coil springs 24 (the cartridge 2 is firmly held by the nails 22 with its lateral edges being seized by the hooks 22a of the nails 22). Then, the cartridge 2 is ready to be moved vertically.

Then, the control unit instructs the carriage driving motor 7 to move the picker 10 and carriage 9 vertically (inferiorly in this particular embodiment) until the picker 10 and carriage 9 are positioned in front of the cartridge drive 3.

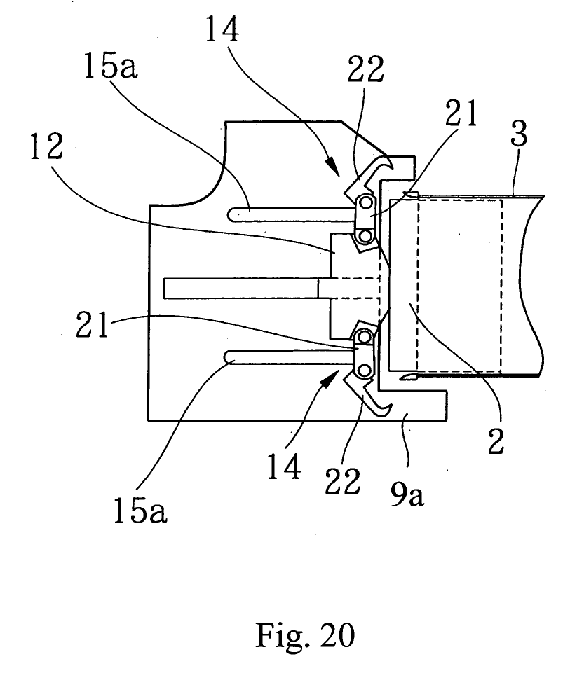

Referring to FIG. 20, the control unit then instructs the cartridge picker driving motor 16 to advance the cartridge picker 10 which still holds the cartridge 2 by means of the hand 12, towards the cartridge drive 3 until the cartridge 2 is transferred in the cartridge drive 3.

At this moment, referring to FIGS. 9 and 12, the lower and upper bushes 25, 25 of each finger arm 21 butt against the corners at the curved sections 15q, 15t of L-shaped cams 15a, 15b, to be forced to slide along the linear sections 15r, 15u, and both fingers 14 are forced to expand. The hooks 22a of the nails 22 are removed from the notches 2a on the lateral edges of the cartridge 2, which is now freed.

The hand 12 enters into a standby state here and keeps that state until it is called for a next transportation operation.

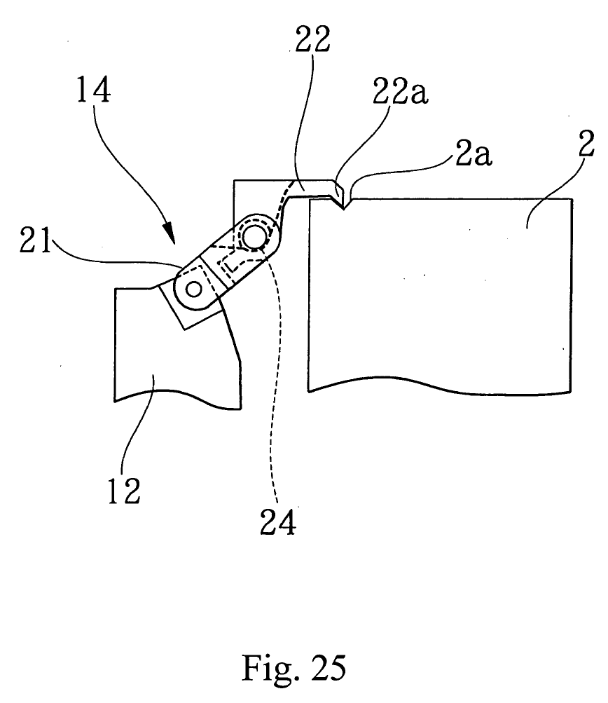

Referring to FIG. 25, when a cartridge 2 has been seized, the hooks 22a of the nails 22 precisely engage with the notches 2a of the cartridge 2, because the cartridge 2 is properly placed in the cartridge holder 4. In this case, the cartridge 2 can be safely transferred in the carriage.

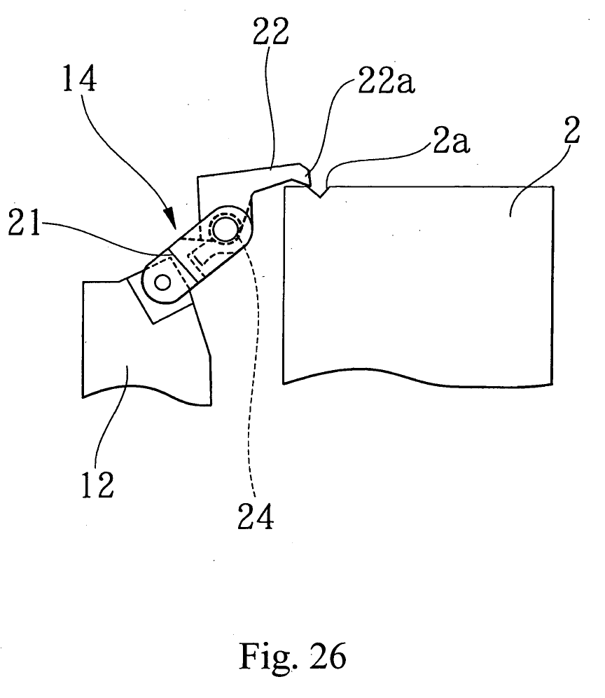

However, referring to FIG. 26, a cartridge 2 may not be properly placed in the cartridge holder 4. In this case, the hooks 22a do not engage properly with the notches 2a of the cartridge 2. However, the hooks 22a can hold the cartridge 2 sufficiently firmly on account of the inward directing force exerted by the twisted coil springs 24. Namely, the inward directing force exerted by the twisted coil springs 24 allows the nails 22 to firmly seize the lateral edges of a cartridge 2. In addition, because the nails 22 are forced to rotate inward independently of each other by respective twisted coil springs 24, they can never fail to seize a cartridge 2.

Referring to FIG. 8, according to this embodiment, the hand 12 is allowed to move back and forth, along the guide groove 19 formed on the carriage base 9a, in the loading and unloading directions, and, with the back and forth movement of the hand 12, the finger shafts 23 slide along the L-shaped cams 15a, 15b formed on the carriage base 9a and cover 9b, to cause the fingers 14 to be narrowed and expanded. Thus, it is possible to obviate the need for rods and cam members which are required in conventional systems, and thus to reduce the number of necessary elements. In addition, the present system can take a simplified structure as compared with conventional systems, which enables weight saving and miniaturization of the system and the reduction of cost.

The guide groove 19 and L-shaped cams 15a, 15b are formed simultaneously with the resin molding of a carriage base 9a or a carriage cover 9b. Because of this, deliberate formation of these elements is not necessary, and molding of a carriage base 9a together with guide groove 19 and L-shaped cams 15a, 15b is easy.

Referring to FIG. 2, in this embodiment, the cartridge picker driving motor 16 is installed apart from the carriage base 9a, instead of on its top, and driving force required for moving the hand 12 is transmitted via the rectangular shaft 28. Because of this, it is possible to reduce the size and weight of the parts of cartridge picker 10 and carriage 9 which are moved by the carriage driving motor 7. In addition, since it is also possible to reduce the size and weight of the carriage driving motor 7 responsible for displacing the carriage 9, reduction of the overall power consumption is possible.

Also, according to the embodiment, it is possible to displace vertically to a position opposite to a desired cartridge holder 4 or to the cartridge drive 3, while the cartridge picker 10 in conjunction with the carriage 9 being kept at a standby state. Thus, the cartridge picker 10 can instantly enter into a state appropriate for seizing a cartridge 2 when required to do so. This reduces the time required for the transportation of a cartridge 2.

Referring to FIGS. 25 and 26, even if a cartridge 2 is not properly placed with respect to a cartridge holder 4 and thus the hooks 22a do not properly engage with the notches 2a, the inward directing force exerted by the twisted coil springs 24 is sufficiently strong to allow the hooks 22a to hold the cartridge 2 firmly. Namely, the inward directing force exerted by the twisted coil springs 24 are so strong as to allow the nails 22 to seize the cartridge 2 as if to enclose it between them. In addition, because the nails 22 are forced to rotate inward independently of each other by respective twisted coil springs 24, they can never fail to seize a cartridge 2.

Referring to FIG. 14, since each twisted coil spring 24 is provided around a finger shaft 23 instead of outside the finger, installment of the finger requires a comparatively small space, which contributes to the compaction of the overall system.

### SECOND EMBODIMENT

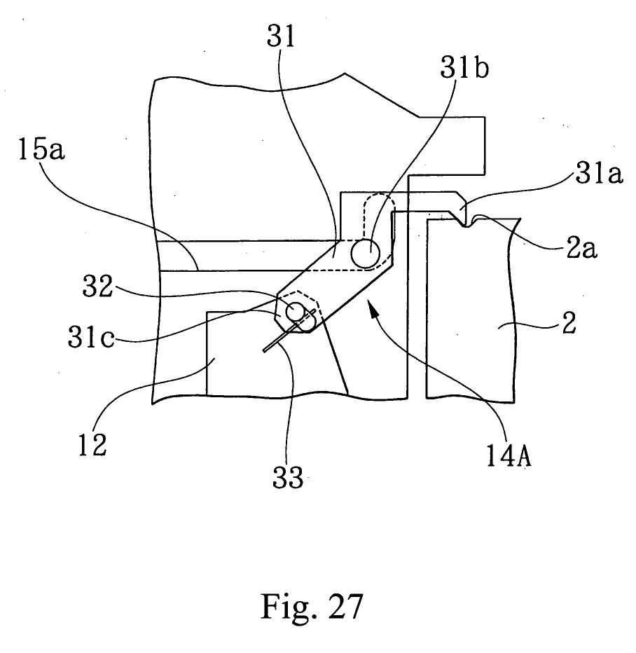

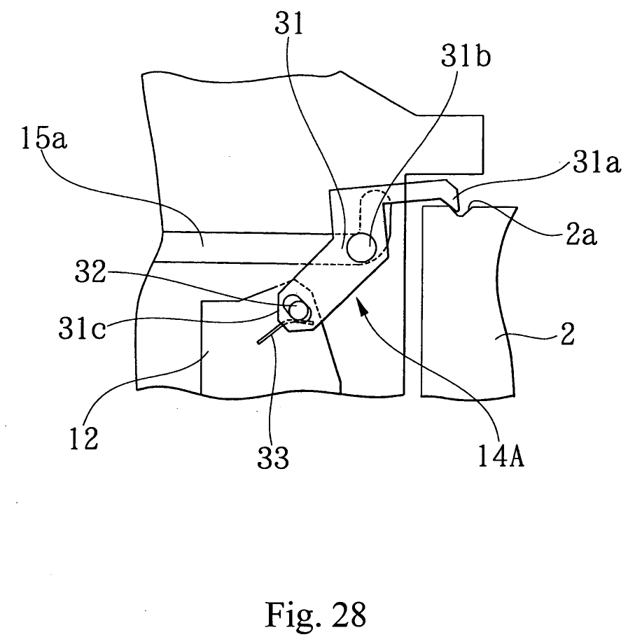

FIG. 27 is a diagram for illustrating the structure of a finger of a storage medium transporting system representing a second embodiment of the invention and equipped with a cartridge picker and carriage, and FIG. 28 a diagram for illustrating the operation of the same transportation system.

The notable feature distinguishing this embodiment from the first embodiment is that each finger arm and nail are integrated, and the finger-nail body is forced to rotate inward by the inward directing force exerted by a strip spring which enables the seizure of a cartridge 2.

Since the other features are nearly the same with those of the first embodiment, their explanation will be simplified.

The finger 14A or an element constituting the cartridge insertion/extraction mechanism of this embodiment comprises a hook 31a on its tip which will engage with a V-shaped notch 2a on a lateral edge of a cartridge 2 as shown in FIG. 27. At the center, the finger 14A comprises a joint 31b which slideably engages with an L-shaped cam 15a. The finger 14A further comprises a finger body 31 which is rotatably linked, on its limb portion 31c, to a hand 12 via a hand shaft 32. The finger 14A further comprises a strip spring 33 which is fixed, on one end, to, the limb portion 31c of the finger 14A and to the hand 12 on the other end so as to force the finger body 31 to rotate inward to hold a cartridge 2.

The operation involved in the insertion or extraction of a cartridge 2 into or from a cartridge holder 4 is nearly the same with that described above with respect to the first embodiment. Also in this embodiment, even if a cartridge 2 is not properly placed with respect to the cartridge holder 4 and thus the hooks 31a do not properly engage with notches 2a, the inward directing force exerted by the strip springs 33 is sufficiently strong to allow the hooks 31a to hold the cartridge 2 firmly as shown in FIG. 28. Namely, the inward directing force exerted by the strip springs 33 is so strong as to allow the finger bodies 31 to seize the cartridge 2 between them. In addition, because the finger bodies 31 are forced to rotate inward independently of each other by respective strip springs 33, they can never fail to seize a cartridge 2.

According to the embodiment having the aforementioned constitution, it is possible to ensure advantages practically the same with those obtained from the first embodiment.

Moreover, since the finger arm and nail are integrated, the number of necessary elements can be reduced, which will reduce the time required for assemblage of the elements, and reduce the cost.

While the preferred embodiments of the present invention have been described in detail with reference to the accompanying drawings, it is to be understood that the structures and constitutions to which the invention is applicable are not limited to those specific embodiments. On the contrary, it is intended that all alternatives and modifications are included in the invention, as long as they are included within the spirit and scope of the invention which are defined by the claims below.

For example, the aforementioned embodiments include a twisted coil spring 24 or strip spring 33 as means for forcing a finger to rotate inward. However, the coil spring may be substituted for a simple torsion spring. For example, tension springs may be introduced in the system in such a manner as to pull the fingers inward.

To support the vertical displacement of the carriage, the lead shaft 8 having a male thread formed thereon is used in the above embodiments. This may be substituted for a shaft with a ball screw.

The rectangular shaft 28 may be substituted for, following variants. The shaft has a convex portion in cross-section, and the through-hole 29a has a concave portion in cross-section, with the convex portion of the former fitting the concave portion of the latter. The cross-section of the rectangular shaft 28 is not necessarily limited to a rectangle but may take a polygonal shape. The relationship of the shaft to the through-hole 29a may be established by way of spline bearing as disclosed in the U.S. Pat. No. 4,629,337. Alternatively, the relationship of the shaft to the through-hole. 29a may be established by way of mating between a key and a keyway as disclosed in U.S. Pat. No. 5,088,306.

In the above embodiments, the cartridge transportation apparatus 1 transports a cartridge 2 from a cartridge holder 4 to the cartridge drive 3 and vice versa. However, the apparatus may be used for transporting a cartridge 2 from one cartridge holder 4 to another. The apparatus may be applied to a system including two or more cartridge drives 3. Then, the apparatus may be used, for example, for transporting a cartridge from one cartridge drive 3 to another.

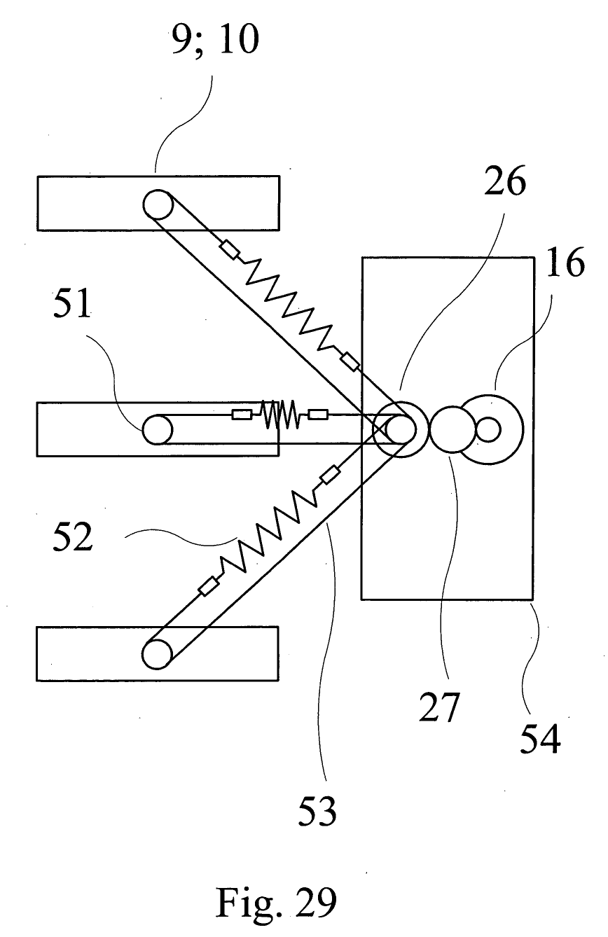

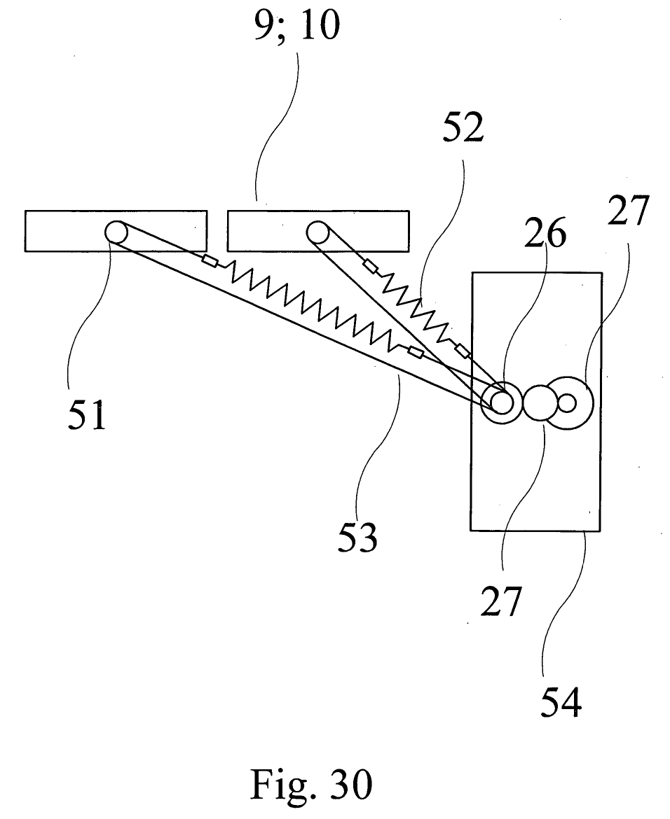

The cartridge transportation system may operate by means of a driving belt. FIG. 29 and FIG. 30 are diagrams for schematically showing the composition of an exemplary cartridge transportation system. A base bracket 54 comprises a cartridge picker driving motor 16 for moving back and forth a cartridge picker 10, an intermediate gear 27 serving as a mediator of the driving force from the motor 16, and a driving gear 26. The base bracket 54 has positioning holes and shafts formed thereon (not shown) such that, when the bracket 54 is fastened to the system by passing shafts through the positioning holes, the base bracket 54 fit precisely to the frame 43 (shown in FIG. 6). The driving gear 26 is linked via a driving belt 53 to a gear 51 such that the rotary force of the former can be transmitted to the latter. The driving belt 53 is elastic and extendable. That is, the driving belt 53 extends and contracts. For example, the driving belt 53 has a spring 52 inserted at one portion such that, even when the cartridge picker 10 and carriage 9 move vertically or horizontally, and thus the distance between the driving gear 26 and the gear 51 changes in association, the tension of the belt 53 may be kept nearly constant. Namely, the tension of the belt 53 can be kept nearly constant, regardless of the position of the cartridge picker 10 and carriage 9 relative to the cartridge picker driving motor 16. According to the system having a structure as described above, it is also possible to reduce the weight of the cartridge picker 10 and carriage 9, because the cartridge picker driving motor 16 is mounted to the system apart from the carriage 9. Reduction of the power consumed by the carriage driving motor 7 will also be possible.

The cartridge 2 is not limited to one packing a magnetic tape, but may include a cartridge packing a storage medium such as a magnetic disk, a compact disk, etc.

The belt 30 is not necessarily an endless belt. In the above embodiments, L-shaped cams 15a and 15b are formed on carriage base 9a and carriage cover 9b, respectively. However, the L-shaped cams may be formed either on the carriage base 9a or on the carriage cover 9b.

In the above embodiments, the system locates a blank holder 4 which does not lodge any cartridge 2, positions the cartridge picker 10 in front of the cartridge holder 4, and advances the hand 12 to expand the fingers 14 to be ready for seizing a cartridge 2. Instead, the system may be modified as follows: a specific cartridge holder 4 is always kept blank, and the system, when turned on, automatically causes the cartridge picker 10 to move in front of the above blank cartridge picker 4 to be ready for seizing a cartridge 2.

When it is required to extract a cartridge 2 from a specified cartridge holder 4 to transport it to the cartridge drive 3, the system may cause the cartridge picker 10 to move in front of the cartridge drive 3 and then the fingers 14 to open to be ready for seizing a cartridge 2.

As described above, according to the cartridge transporting system embodying the invention, the cartridge picker driving motor is fixed to the base bracket or a member apart from the carriage, in stead of on the carriage base. Because of this, it is possible to reduce the size and weight of the parts of the cartridge picker and the carriage which require, for their operation, driving force from the carriage driving motor 7. In addition, since it is also possible to reduce the size and weight of the cartridge picker and carriage, reduction of the overall power consumption is possible.

According to an embodiment of the invention, the cartridge picker comprises a nail opening/closing means where a pair of fingers and a pair of nails are integrated. Thus, it is possible to obviate the need for complicated rods and cam members which are required in conventional systems, and thus to reduce the number of necessary elements. In addition, the embodiment can take a simplified structure as compared with conventional systems, which enables weight saving and miniaturization of the system and the reduction of cost.

Further, the guide groove which serves as a guide means of the cartridge picker may be integrated with the carriage base. Then, the resulting system can eliminate the use of rods and other members required for guiding the cartridge picker, and thus reduce the number of necessary elements. In addition, the system can take a simplified structure as compared with conventional systems, which enables weight saving and miniaturization of the system and the reduction of cost.

While this invention has been described with reference to illustrative embodiments, this description is not intended to be construed in a limiting sense. Various modifications of the illustrative embodiments will be apparent to persons skilled in the art upon reference to this description. It is, therefore, contemplated that the appended claims will cover any such modifications or embodiments as fall within the true scope of the invention.

What is claimed is:

1. An apparatus for transporting a storage medium from a holder to a storage device, said apparatus comprising:
a base;
a carriage driven by first driving force, said carriage being movable relative to said base between said holder and said storage device;
a picker provided on said carriage and driven by second driving force, said picker selectively loading and unloading said storage medium;
a first driving device generating said first driving force;
a second driving device provided on said base and generating said second driving force; and
a transmission mechanism transmitting said second driving force from said driving device to said picker allowing movement of said carriage.

2. An apparatus according to claim 1, wherein
said transmission mechanism comprises a rotary shaft and a coupling device, and
said coupling device is provided on said carriage and transmits torque from said rotary shaft to said picker allowing relative movement between said rotary shaft and said picker along a longitudinal axis of said rotary shaft.

3. An apparatus according to claim 2, wherein
said rotary shaft has a convex portion in cross section,
said coupling device has a concave portion in cross section, and
said convex portion of said rotary shaft fits said concave portion of said coupling device.

4. An apparatus according to claim 3, wherein said rotary shaft has a polygonal shape in cross section.

5. An apparatus according to claim 4, wherein said rotary shaft has a rectangular shape in cross section.

6. An apparatus according to claim 2, wherein said coupling device comprises a spline bearing.

7. An apparatus according to claim 2, wherein said rotary shaft and said coupling device engages each other by means of a key and a keyway.

8. An apparatus according to claim 1, wherein
said transmission mechanism comprises a belt and a gear,
said belt allows relative movement between said driving device and said picker, and
said gear is provided on said carriage and transmits driving force from said belt to said picker.

9. An apparatus according to claim 8, wherein said belt is elastic.

10. An apparatus according to claim 9, wherein said belt comprises a spring.

11. An apparatus according to claim 1, wherein said picker comprises a gripper assembly grasping said storage medium.

12. An apparatus according to claim 11, wherein said picker comprises a support structure translating,said gripper assembly in a direction toward and away from said holder.

13. An apparatus according to claim 12, wherein
said gripper assembly comprises an arm and a guide guiding said arm,
said arm selectively assumes an open position and a closed position,
said guide has a curved portion such that said arm moves from said closed position to said open position as said arm approaches said holder and said arm moves from said open position to said closed position as said arm retreats from said holder.

14. An apparatus according to claim 1, wherein said holder is a library.

15. An apparatus according to claim 1, wherein said storage medium is housed in a cartridge.

16. A storage medium library system comprising:
one or more storage holders which holds said storage media;
a base;
a carriage driven by first driving force, said carriage being movable relative to said base between said holder and said storage device;
a picker provided on said carriage and driven by second driving force, said picker selectively loading and unloading said storage medium;
a first driving device generating said first driving force;
a second driving device provided on said base and generating said second driving force; and
a transmission mechanism transmitting said second driving force from said driving device to said picker allowing movement of said carriage.

17. An apparatus for transporting a storage medium from a holder to a storage device, said apparatus comprising:
base means;
carriage means movable relative to said base means between said holder and said storage device, said carriage means is driven by first driving force;
picker means for selectively loading and unloading said storage medium, said picker means being provided on said carriage means and driven by second driving force,;
first driving means for generating said first driving force;
second driving means for generating said second driving force, said second driving means being provided on said base means; and
transmission means for transmitting said second driving force from said second driving means to said picker means allowing movement of said, carriage means.
